(19) United States
(12) Patent Application Publication
(10) Pub. No.: US 2026/0012081 A1
(43) Pub. Date: Jan. 8, 2026

(54) METHODS AND APPARATUS TO ADJUST LOAD TRANSIENT MARGINS

(71) Applicant: Texas Instruments Incorporated, Dallas, TX (US)

(72) Inventors: Matthew John Ascher Schurmann, Wylie, TX (US); Vikram Gakhar, Bengaluru (IN); Preetam Charan Anand Tadeparthy, Bengaluru (IN)

(21) Appl. No.: 18/763,886

(22) Filed: Jul. 3, 2024

(51) Int. Cl. H02M 1/088; H02M 7/217

(52) U.S. Cl. CPC H02M 1/088; H02M 7/217

(57) ABSTRACT

An example apparatus to adjust load transient margins includes: memory configured to store a value representative of a threshold voltage; programmable circuitry having: a first input terminal coupled to the memory; a second input terminal; and an output terminal; the controller circuitry configured to: receive, at the second input terminal, an indication of an output voltage; adjust, in response to a determination that the output voltage is outside the threshold voltage, an offset value; and provide, at the output terminal, an output signal based on the offset value.

### TECHNICAL FIELD

This description relates generally to power supply circuitry, and, more particularly, to methods and apparatus to adjust load transient margins.

### BACKGROUND

Power management circuitry is a critical design component of any electronic device. In general, power management circuitry refers to hardware and software that converts a first voltage and a first current received from a source into a second voltage and second current that is consumable by a load. Power sources may include, but are not limited to, 120 volts alternating current (VAC) or 240 VAC wall outlets, batteries, generators, power provided by solar cells, etc. Power management circuitry may also convert the power from a first type (e.g., alternating current (AC)) to a second type (e.g., direct current (DC)) that is usable by the load.

### SUMMARY

For methods and apparatus to adjust load transient margins, an example apparatus includes: memory configured to store a threshold voltage; programmable circuitry having: a first input terminal coupled to the memory; a second input terminal; and an output terminal; the programmable circuitry configured to: measure an output voltage; decrease, in response to a determination the output voltage exceeds the threshold voltage, an offset value; and provide an output signal based on the offset value.

### BRIEF DESCRIPTION OF THE DRAWINGS

FIG. 1 is an example of power delivery that includes switching converter circuitry.

FIG. 2 are example graphs illustrating the performance of the switching converter circuitry 108 of FIG. 1 with and without Direct Current Load Line (DCLL) operations.

FIG. 3 is an example block diagram of the switching converter circuitry of FIG. 1.

FIG. 4 are graphs illustrating the performance of a power stage controller device operating with high frequency transients and without offsets.

FIG. 5 are graphs illustrating the performance of the switching converter circuitry of FIG. 1 when operating with high frequency transients and with offsets.

FIG. 6 is a first flowchart representative of example machine-readable instructions or example operations that may be at least one of executed, instantiated, or performed using an example programmable circuitry implementation of the multiphase manager circuitry 302 of FIG. 3.

FIG. 7 is a second flowchart representative of example machine-readable instructions or example operations that may be at least one of executed, instantiated, or performed using an example programmable circuitry implementation of the multiphase manager circuitry 302 of FIG. 3.

FIG. 8 is a block diagram of an example processing platform including programmable circuitry structured to execute, instantiate, or perform the example machine-readable instructions or perform the example operations of FIGS. 6 and 7 to implement the multiphase manager circuitry 302 of FIG. 3.

The drawings are not necessarily to scale. Generally, the same reference numbers in the drawing(s) and this description refer to the same or similar (functionally or structurally) features or parts. Although the drawings show regions with clean lines and boundaries, some or all of these lines and boundaries may be idealized. In reality, the boundaries or lines may be unobservable, blended or irregular.

### DETAILED DESCRIPTION

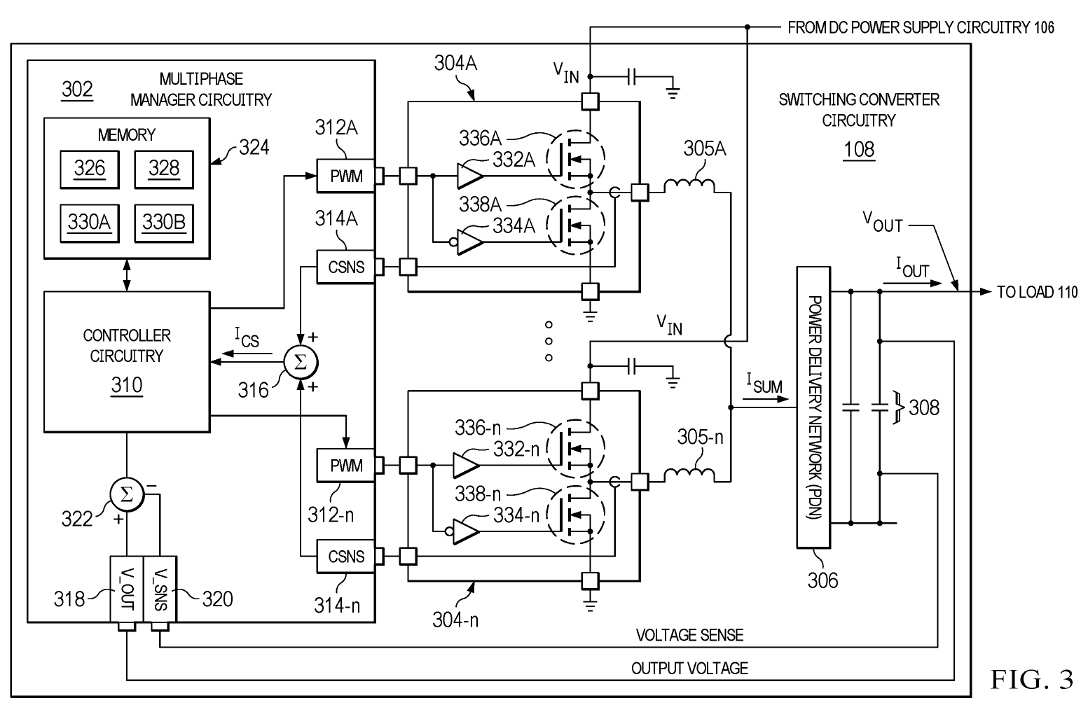

Power management circuits may be implemented in a wide variety of architectures. One example of such an architecture is power stage circuits, which include transistors rated for high power operations. The transistors turn ON and OFF at specific timing sequences to deliver an amount of power to a load. An example implementation of power stage circuits is discussed in connection with FIG. 3.

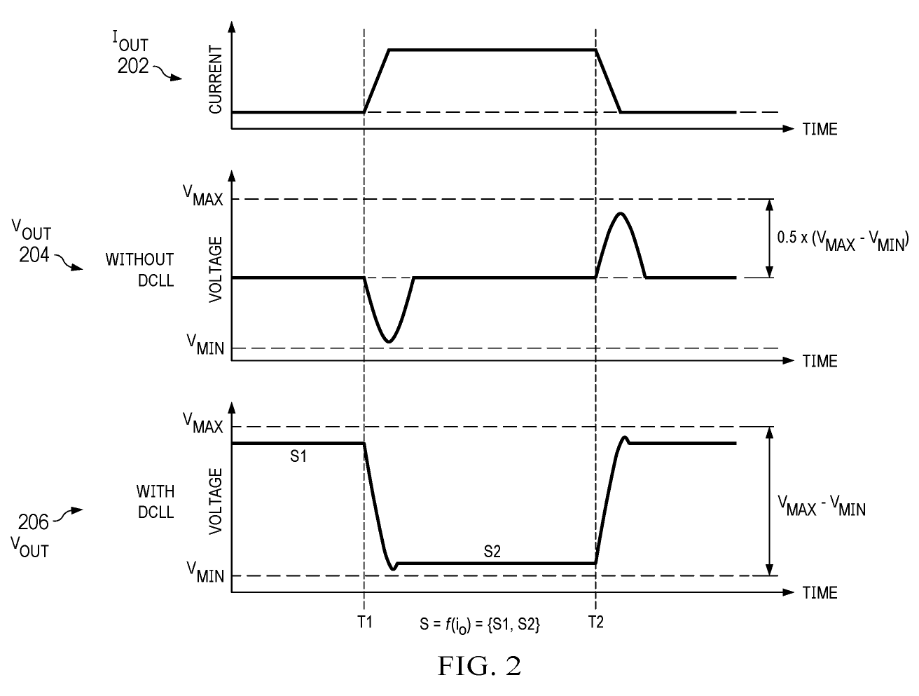

The operations performed by power stage circuits are responsive to the power requirements of the load. In some examples, power stage circuitry performs DCLL operations to support a cost-effective implementation of the circuit that can respond to the changing power requirements while remaining in a safe voltage range. DCLL operations are discussed further in connection with FIG. 2.

Power stage circuits perform operations responsive to an input signal provided by control circuitry. To generate the input signal in a manner that causes DCLL operations to occur, the control circuitry requires a measurement of the current flowing through an output terminal of the power stage circuitry.

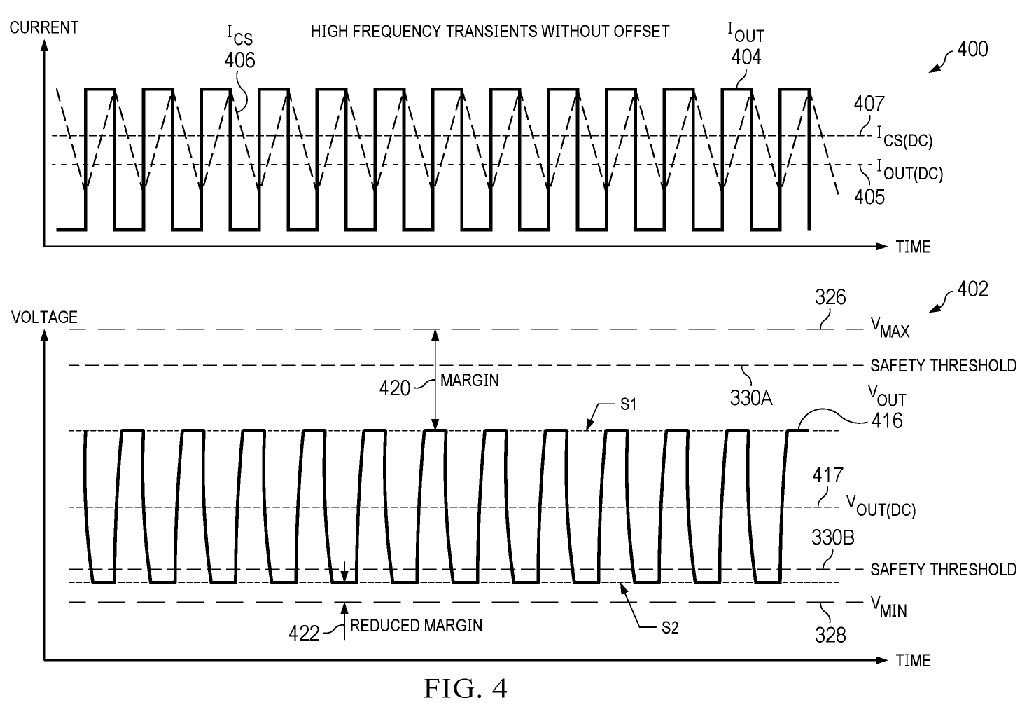

Other controller devices that support DCLL operations rely on the power stage circuitry to self-report their own output current using a current sense (C_{SNS}) terminal. While the C_{SNS} signal provided to the controller device is accurate some of the time, it becomes inaccurate in certain use cases (e.g., when the power requirements of the load cause the controller device to the power stage device with high frequency transients). In such use cases, controller devices that rely on the C_{SNS} signal will receive an inaccurate current measurement and therefore implement DCLL operations inaccurately. Such controller devices may in turn provide an inaccurate amount of power to the load or exceed a safety voltage rating as discussed further in connection with FIG. 4. Accordingly, controller devices that rely on the C_{SNS} signal to perform DCLL operations are limited in the types of power requirements they can support from a load.

Example methods, apparatus, and systems described herein implement a controller device that can perform DCLL operations without reliance on a self-reported value from power stage circuitry. Rather than using the C_{SNS} signal, the controller device described herein computes the current flowing through the power stage circuits based on a measurement of the output voltage provided to the load (e.g., using a different input that was already available to the controller device for to perform voltage regulation operations). Accordingly, the example controller device determines accurate current values and perform DCLL operations accurately even when the power requirements of the load cause the controller to operate in a use case that causes the C_{SNS} signal to become inaccurate. Therefore, the example controller device described herein can support a greater variety of power requirements from a load than other techniques to perform DCLL operations.

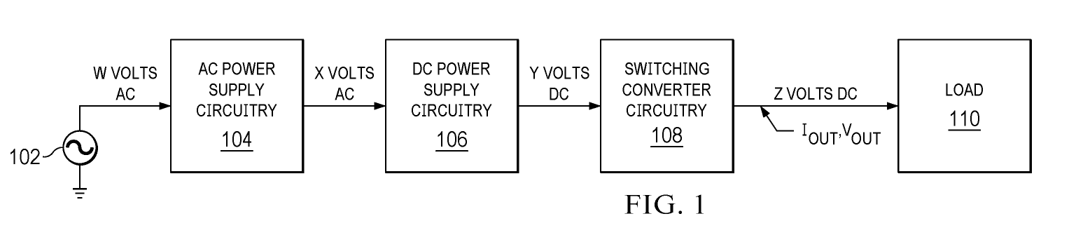

FIG. 1 is an example of power delivery that includes switching converter circuitry. FIG. 1 includes an example power source 102, an example AC power supply circuitry 104, example DC power supply circuitry 106, example switching converter circuitry 108, and an example load 110.

The power source 102 provides AC power. The power source 102 may be implemented by any device providing electrical energy in AC. For example, in FIG. 1, the example power source 102 is implemented by a 120 VAC outlet.

The AC power supply circuitry 104 transforms the 120 VAC into a different AC signal that is operable upon by the DC power supply unit. In particular, the AC power supply circuitry 104 may alter one or more of the voltage, frequency, shape of signal, number of phases, etc., depending on the type of the power source 102 and the requirements of the DC power supply unit.

The DC power supply circuitry 106 transforms the AC signal received from the AC power supply circuitry 104 into a DC signal. The DC power supply circuitry 106 includes rectifier circuitry and filter circuitry to convert the AC signal to a DC signal. The DC power supply circuitry 106 can provide a DC signal at a voltage that is operable by the switching converter circuitry 108. In some examples, the DC power supply circuitry 106 is referred to as a voltage source.

The switching converter circuitry 108 transforms, as described herein, the first DC voltage provided by the example DC power supply circuitry 106 into a second DC voltage usable by the load 110. The switching converter circuitry 108 is described further in connection with FIG. 2.

In FIG. 1, the example load 110 is an electronic device that uses the second DC voltage to perform operations. The load 110 may be implemented as any type of electronic device, including but not limited to programmable circuitry, a transceiver, volatile memory, etc.

FIG. 2 are example graphs illustrating the performance of the switching converter circuitry 108 of FIG. 1 with and without DC Load Line (DCLL) control. FIG. 2 includes example signals 202, 204, and 206. The x axes of the graphs of FIG. 2 are vertically aligned such that T1 and T2 refer to the same points in time for each of the signals 202 - 206.

The signal 202 represents how the current flowing from the switching converter circuitry 108 to the load 110 (represented herein as I_{OUT}) changes over time. The amount of current flowing to the load 110 may change at any time and for any reason. In general, the amount of current changes responsive to the requirements of the load 110. For example, suppose the load 110 is a type of programmable circuitry that performs different types and amounts of operations at different times. If the load 110 begins performing additional operations or more complex operations than a previous mode of operation, the load 110 may draw additional current from the switching converter circuitry 108 to power the new operations. The signal 202 shows I_{OUT} begins to ramp up at T1 from the first amperage to a second amperage. I_{OUT} then begins to ramp down from the second amperage at T2, ultimately returning to the first amperage.

In general, the switching converter circuitry 108 regulates V_{OUT} by performing operations to maintain the value of the output voltage provided from the switching converter circuitry 108 to the load 110 (which may be represented herein as V_{OUT}) at a setpoint voltage. The switching converter circuitry 108 is rated with a maximum voltage (which may be represented herein as V_{MAX}) and a minimum voltage (which may be represented herein as V_{MIN}). That is, to ensure the device behaves properly and does not cause damage or pose safety hazards to itself or the load 110, the switching converter circuitry 108 is required to set the setpoint voltage between [V_{MIN}, V_{MAX}]. Moreover, because V_{OUT} does change values in some use cases, the switching converter circuitry 108 is also required to ensure sure the value of V_{OUT} never exceeds (e.g., becomes greater than) V_{MAX} or falls below (e.g., becomes less than) V_{MIN}.

The signal 204 represents changes to V_{OUT} that may occur in response to the signal 202 if the switching converter circuitry 108 does not perform DCLL control operations. When the load 110 causes I_{OUT} to increase at T1, V_{OUT} initially decreases because the switching converter circuitry 108 has not yet had time to respond and provide additional power. Eventually, the power stage control device and the value of V_{OUT} returns to the setpoint voltage. Similarly, at T2, the change in I_{OUT} causes V_{OUT} to increase for a period before settling back at the setpoint voltage. In examples described herein, the period when V_{OUT} is less than a setpoint voltage may be referred to as undershoot, and the period when V_{OUT} is greater than a setpoint voltage may be referred to as overshoot.

In the signal 204, the setpoint voltage is set equidistant between V_{MIN} and V_{MAX}. As a result, the magnitude of any overshoot produced in the signal 304 has to remain within 0.5(V_{MAX} - V_{MIN}) in order to meet the rating requirements of the switching converter circuitry 108.

The signal 206 represents changes to V_{OUT} that may occur in response to the signal 202 if the switching converter circuitry 108 does perform DCLL control operations. In general, DCLL control operations refers to a mode of operation where the switching converter circuitry 108 no longer regulates V_{OUT} to a single setpoint voltage. Instead, DCLL control operations cause the switching converter circuitry 108 to change the setpoint voltage of V_{OUT} as a function of the value of I_{OUT}. For example, when I_{OUT} is at the first amperage before T1, the switching converter circuitry 108 sets the setpoint voltage to S1. The value of S1 is close to, but less than, the value of V_{MAX}. When I_{OUT} increases begins to increase at T1, the switching converter circuitry lowers the setpoint voltage to S2. The value of S2 is close to, but greater than, the value of V_{MIN}. Similarly, when I_{OUT} begins to decrease at T2, the switching converter circuitry increases the setpoint voltage back to S1.

Notably, (S1 - S2) > 0.5(V_{MAX} - V_{MIN}). As such, DCLL control operations allow the switching converter circuitry 108 to operate with a larger overshoot and undershoot while keeping V_{OUT} within V_{MAX} and V_{MIN}. By supporting larger overshoot and undershoot for the same voltage rating, the switching converter circuitry 108 can be manufactured using less expensive components and fewer components than other circuits that do not use DCLL control operations.

FIG. 3 is a block diagram of an example implementation of the switching converter circuitry 108 of FIG. 1 to provide V_{OUT} and I_{OUT} to the load 110. The switching converter circuitry 108 of FIG. 3 may be instantiated (e.g., creating an instance of, bring into being for any length of time, materialize, implement, etc.) by hardware, or by programmable circuitry such as a Central Processor Unit (CPU) executing first instructions. Also or alternatively, the switching converter circuitry 108 of FIG. 3 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 3 may, thus, be instantiated at the same or different times. Some or all of the circuitry of FIG. 3 may be instantiated, for example, in one or more threads executing concurrently on hardware or in series on hardware. Moreover, in some examples, some or all of the circuitry of FIG. 3 may be implemented by microprocessor circuitry executing instructions or FPGA circuitry performing operations to implement one or more virtual machines or containers. In FIG. 3, the switching converter circuitry 108 includes example multiphase manager circuitry 302, example power stage circuitry 304A … 304-n (which may be collectively referred to as power stage circuits 304), an example power delivery network (PDN) 306, and example capacitors 308. The example multiphase manager circuitry 302 includes controller circuitry 310, example pulse width modulation (PWM) terminals 312A … 312-n (which may be collectively referred to as PWM terminals 312), example current sense (C_{SNS}) terminals 314A … 314-n (which may be collectively referred to as C_{SNS} terminals 314), example adders 316 and 322, an example V_{OUT} terminal 318, an example sense voltage (V_{SNS}) terminal 320, and example memory 324. The memory 324 includes an example V_{MAX} value 326, an example V_{MIN} value 328, and example safety threshold values 330A and 330B. A given power stage circuit 304A includes two complementary buffers 332A and 334A, a high side power transistor 336A, and a low side power transistor 3368.

The multiphase manager circuitry 302 provides signals to the power stage circuits 304 that cause the power stage circuits 304 to deliver power to the load 110. The signals delivered from the multiphase manager circuitry 302 to the power stage circuits 304 are analog signals transmitted over the PWM terminals 312. Accordingly, the foregoing signals may be referred to as PWM signals. As described further below, the multiphase manager circuitry 302 determines what voltages to provide on the PWM terminals 312 responsive to the power requirements of the load 110 and the voltage across the capacitors 308. In some examples, the a PWM terminal 312A may be referred to as an output terminal, and the corresponding PWM signal may be referred to as an output signal.

The power stage circuits 304 deliver power to the load 110 based on the PWM signals from the multiphase manager circuitry 302. The power stage circuitry 304A receives a constant input voltage from the example DC power supply circuitry 106 (labelled V_{IN} in FIG. 3) and a PWM signals from a corresponding PWM terminal 312A. The power stage circuitry 304A then changes the current and voltage provided to the load 110 based on the duty cycle within the PWM signal. For example, the power stage circuitry 304A may increase the current and voltage provided to the load 110 in response to the duty cycle of the PWM signal sent over the PWM terminal 312A increasing. Similarly, the power stage circuitry 304A may decrease the current and voltage provided to the load 110 in response to the duty cycle of the signal sent over the PWM terminal 312A decreasing.

A PWM signal is generally composed of a rectangular waveform whose pulse width and timing are determined by the multiphase manager circuitry 302. As used above and herein, the duty cycle of the PWM signal refers to the ratio between the pulse width and period of the rectangular waveform.

To perform the above-described voltage and current transformation, the power stage circuits 304 described herein are implemented in a buck converter architecture. In some examples, the power stage circuitry 304A also includes an inductor 305A. In the example of FIG. 3, the inductor 305A is implemented outside of the power stage circuitry 304A but is coupled to the high side power transistor 336A and low side power transistor 338A within the power stage circuitry 304A. In other examples, the power stage circuits 304 are implemented using a different topology. Such topologies may include, but are not limited to, coupled inductor, trans-inductor voltage regulator (TLVR), etc.

The controller circuitry 310 provides the PWM signal to the complementary buffers 332A and 332B. The complementary buffers 332A and 332B are complementary in the sense that the output of the two devices remain at logical opposites in response to the PWM signal. That is, the output of the complementary buffer 332A is a logical ‘1’ whenever the output of the complementary buffer 332B is a logical ‘0’, and vice versa. The power stage circuitry 304A includes the complementary buffers 332A and 332B to prevent the high side power transistor 336A and the low side power transistor 338A from operating ON at the same time and forming a short circuit. In some examples, the complementary buffers 332A and 332B additionally increase the gain of the PWM signal. The buffer 332A is coupled to the gate (e.g., the control terminal) of the high side power transistor 336A and the buffer 334A is coupled to the gate of the low side power transistor 338A.

The high side power transistor 336A and low side power transistor 338A are both transistors rated for high-power applications. The high side power transistor 336A and the low side power transistor 338A are coupled to one another, and to the inductor 305A, through a switch terminal. When the voltage at the output of the buffer 332A crosses a threshold, the high side power transistor 336A turns ON, causing current to flow from the DC power supply circuitry 106 and through the inductor 305A via the switch terminal. Alternatively, when the voltage at the output of the buffer 334A crosses a threshold, the low side power transistor 338A turns on and the current from the switch terminal flows to ground. In turn, current flowing through the inductor 305A decreases when the low side power transistor 338A is ON. Accordingly, by adjusting the width and timing of pulses provided over the PWM terminal 312A, the control circuitry 310 changes the value of V_{OUT} and I_{OUT} to meet the power requirements of the load 110.

In the example of FIG. 3, the high side power transistors 336 and low side power transistors 338 are n-channel metal-oxide semiconductor field-effect transistors (MOSFETs). Alternatively, the high side power transistors 336 and low side power transistors 338 may be n-channel field-effect transistors (FETs), n-channel insulated-gate bipolar transistors (IGBTs), n-channel junction field effect transistors (JFETs), NPN bipolar junction transistors (BJTs) or, with slight modifications, p-type equivalent devices. The high side power transistors 336 and low side power transistors 338 may be depletion mode devices, drain-extended devices, enhancement mode devices, natural transistors, or other type of device structure transistors. Furthermore, the high side power transistors 336 and low side power transistors 338 may be implemented in/over a silicon substrate (Si), a silicon carbide substrate (SiC), a gallium nitride substrate (GaN) or a gallium arsenide substrate (GaAs).

The switching converter circuitry 108 may implement n individual power stage circuits 304, where n is any positive integer. Accordingly, the switching converter circuitry 108 also includes n inductors 305, n PWM terminals 312, and n C_{SNS} terminals 314.

The two complementary buffers 332A and 334A, high side power transistor 336A, and low side power transistor 338A within the power stage circuitry 304A collectively produce approximately (1/n) of the current provided to the load 110. When the n individual signals are produced by the other power stage circuits, the collective current produced by the power stage circuits 304 may be referred to as I_{SUM}.

The PDN 306 refers to the set of interconnects, printed circuit board (PCB) traces, vias, ports, pins, terminals, etc. that collectively couple the load 110 to the rest of the switching converter circuitry 108. The size of the PDN 306 and components within the PDN 306 may vary based on design restraints such as cost, use case, complexity, and position of other components on a corresponding integrated circuit (IC) or PCB, etc. The components of the PDN 306 have DC resistivity and parasitic capacitance that can impede the flow of current. Accordingly, the output current (I_{OUT}) provided to the load 110 is less than I_{SUM}.

The capacitors 308 are coupled to both the PDN 306 and the load 110. The capacitors 308 may store or discharge current based on the value of I_{OUT}. In general, the capacitors 308 are used to attenuate undesired electrical noise as power is delivered to the load 110. The output capacitors also minimize the change in output voltage due to the occurrence of undesired changes to I_{OUT}.

Within the multiphase manager circuitry 302, the controller circuitry 310 manages the operation of the power stage circuits 304 to meet the power requirements of the load 110. The controller circuitry 310 obtains a current signal from the adder 316, a voltage signal from the adder 322, and data from the memory 324. The controller circuitry 310 then determines when and how to adjust the voltages on the PWM terminals 312 based on one or more of the foregoing inputs.

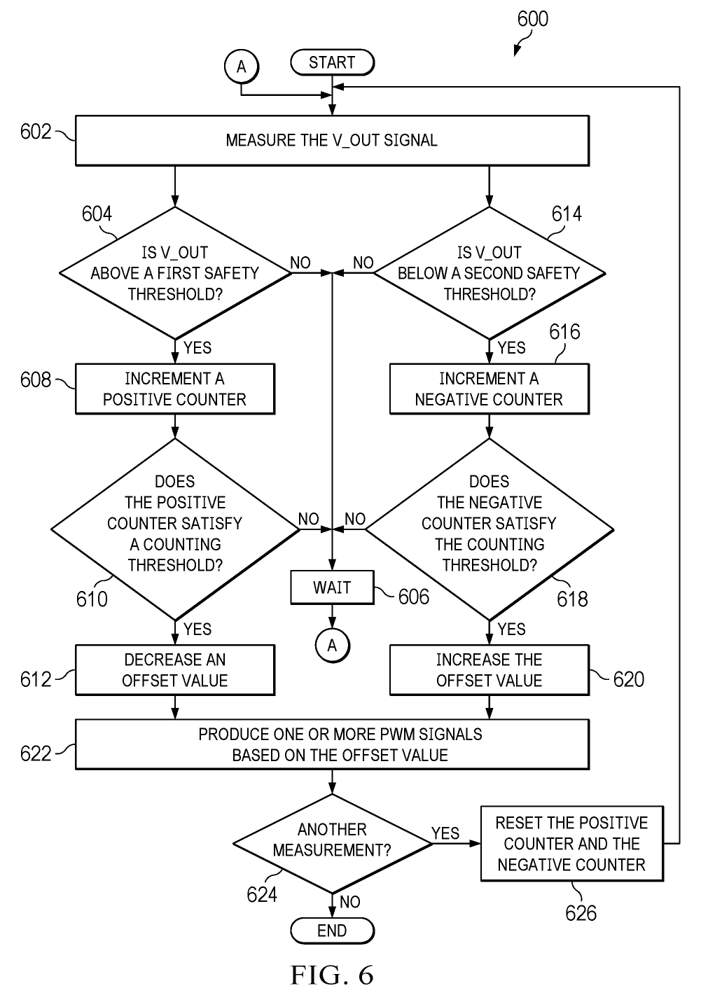

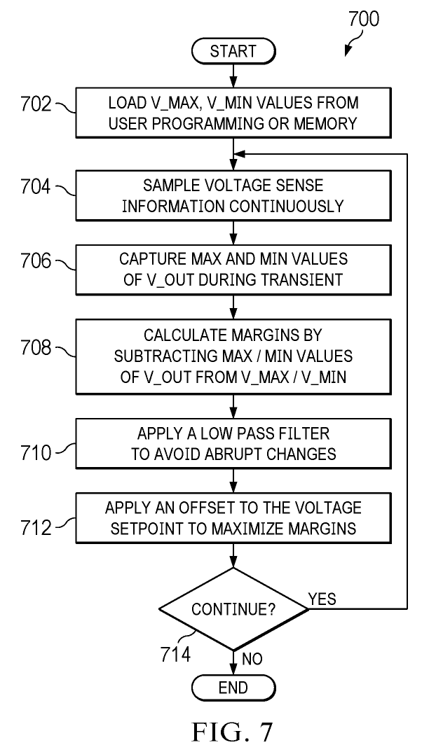

The controller circuitry 310 may be implemented by any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). In some examples, the controller circuitry 310 is instantiated by programmable circuitry executing controller instructions to perform operations such as those represented by the flowchart(s) of FIGS. 6 and 7.

The C_{SNS} terminals 314 are coupled to the respective power stage circuits 304 (e.g., the C_{SNS} terminal 314A couples to the power stage circuitry 304A, etc.). The power stage circuitry 304A provides a voltage at the C_{SNS} terminal 314A that is proportional to the current flowing to the inductor 305A.

The adder 316 adds the voltages from the C_{SNS} terminals 314 together and provides the sum to the controller circuitry 310. The voltage output from the adder 316 is labeled I_{CS} in FIG. 3 and is meant to represent I_{OUT}, the current flowing to the load 110. Accordingly, some power management circuits perform DCLL control operations based on the output of the adder 316 rather than directly measuring the value of I_{OUT}. Power management circuits generally do not directly measure the value of I_{OUT} because the controller circuitry 310 already requires current measurements of the individual power stage circuits 304 for safety purposes (e.g., over-current protection). As such, adding a sense resistor and amplifier circuits to directly measure I_{OUT} is redundant, more expensive, and more complex than computing the sum of the voltages from the C_{SNS} terminals 314.

The V_{OUT} terminal 318 is coupled to the positive terminal of the capacitors 308 and the V_{SNS} terminal 320 is coupled to the negative terminal of the capacitors 308. The adder 322 then subtracts the voltage at the V_{SNS} terminal 320 from the voltage of the V_{OUT} terminal 318. Accordingly, the output of the adder 322 represents the output voltage provided to the load 110. In some examples, one or more of the C_{SNS} terminals 314, the V_{OUT} terminal 318, and the V_{SNS} terminal 320 may be referred to as an input terminal.

The memory 324 stores data used by the controller circuitry 310 to set the PWM signals. Such data includes the V_{MAX} value 326, the V_{MIN} value 328, the safety threshold values 330A and 330B as described further below. The memory 324 may also include additional data used by the controller circuitry 310. Such additional data including but not limited to the setpoint voltages used during DCLL control operations (e.g., the values of S1 and S2 in FIG. 2), the electrical characteristics of other components in the switching converter circuitry 108, counter values, etc. In some examples, a safety threshold value is referred to as a safety threshold voltage.

The memory 324 may be implemented as any type of memory. For example, the memory 324 may be a volatile memory or a non-volatile memory. The volatile memory may be implemented by Synchronous Dynamic Random Access Memory (SDRAM), Dynamic Random Access Memory (DRAM), or any other type of RAM device. The non-volatile memory may be implemented by flash memory or any other desired type of memory device.

In the example of FIG. 3, the adders 316 and 322 are implemented externally from the controller circuitry 310. In other examples, the one or more of the adders 316 and 322 are implemented within the controller circuitry 310. Similarly, in some examples, the controller circuitry 310 obtains one or more of the V_{MAX} value 326, the V_{MIN} value 328, or the safety threshold values 330A and 330B as signals from an external device instead of obtaining said values as data stored in memory 324.

As used above and herein, operating the power stage circuits 304 may refer to turning the high side primary transistors 336 and the low side primary transistors 338 ON and OFF at various times to provide an appropriate amount of power to the load 110. In some use cases, the power requirements of the load 110 cause the controller circuitry 310 to operate the power stage circuits 304 at a relatively high rate. Such operations may be referred to as a high frequency transient mode. The high frequency change of transistor state causes high frequency changes to the value of I_{OUT} that, in some examples, occur too quickly for the power stage circuits 304 to accurately update the corresponding voltage at the C_{SNS} terminals 314. This loss in accuracy may vary based on the type of current sense architecture used by the power stage circuits 304 and may occur for any number of reasons, including but not limited to noise considerations, signal range, etc. Accordingly, controller devices that rely on C_{SNS} signals from power stage circuits to perform DCLL control operations may be unable to support high frequency transient use cases.

Example methods, systems, and apparatus described herein implement switching converter circuitry that perform DCLL control operations without relying on C_{SNS} signals from power stage circuits. Example controller circuitry 310 implements DCLL control operations by switching the setpoint voltage of V_{OUT} based on the value of I_{OUT}. To determine the value of I_{OUT}, the controller circuitry 310 measures the value of V_{OUT} (using the VOUT terminal 318, the VSNS terminal 320, and the adder 322) and divides V_{OUT} by a load line resistance R_{LL} value stored in the memory 324. In some examples, R_{LL} is referred to as a DCLL value.

FIG. 4 are graphs illustrating the performance of a power stage controller device when operating with high frequency transients and without offsets. FIG. 4 includes example graphs 400 and 402. Graph 400 includes an example I_{OUT} signal 404, an I_{OUT(DC)} signal 405, and an example I_{CS} signal 406, and an example I_{CS(DC)} signal 407. Graph 402 includes the V_{MAX} value 326, the V_{MIN} value 328, the safety threshold values 330A and 330B, an example V_{OUT} signal 416, and an example V_{OUT(DC)} signal 417.

The I_{OUT} signal 404 shows how the output current flowing through the load 110 changes over time. The I_{OUT} signal 404 is a square waveform that alternates between a high amperage value and a low amperage value. In the example of FIG. 2, the power requirements of the load 110 require the power stage circuits 304 to operate in high frequency transients. As a result, the amount of time between pulses in the I_{OUT} signal 404 is relatively small. The I_{OUT(DC)} signal 405 represents the average value of the I_{OUT} signal 404 over time.

The I_{CS} signal 406 shows how the current flowing into the PDN 306 changes over time. The current flowing into the PDN 306 is the sum of the current flowing out of the individual power stage circuits 304. The controller circuitry 310 obtains the value of the I_{CS} signal 406 from the adder 316, which adds voltages from the respective C_{SNS} terminals 314 together. The I_{CS(DC)} signal 407 represents the average value of the I_{OUT} signal 404 over time.

In the example of FIG. 2, the high frequency transients required by the load 110 cause the I_{OUT} signal 404 to change too quickly for the power stage circuits 304 to accurately update the C_{SNS} terminals 314. The inaccurate voltages at the C_{SNS} terminals 314 in turns cause the I_{CS} signal 406 to be inaccurate. For example, because the I_{OUT} signal 404 alternates between the high amperage value and the low amperage value, an accurate version of the I_{CS} signalis composed of data points at the same two amperage values. In FIG. 2, however, the I_{CS} signal 406 has data points at the high amperage value and at a third amperage value that is larger than the low amperage value. As a result, the I_{CS(DC)} signal 407 is unequal to the I_{OUT(DC)} signal 405 and the I_{CS} signal 406 is not an accurate representation of the I_{OUT} signal 404.

The inaccurate I_{CS} signal 406 can cause the controller circuitry 310 to send incorrect PWM signals to the power stage circuits 304. In controller devices that do not apply an offset to VOUT as described herein, such inaccuracies may decrease the performance of the switching converter circuitry 108. For example, one performance metric used to evaluate the switching converter circuitry 108 is voltage margin. Voltage margin refers to a value that quantifies how close the VOUT signal provided to the load 110 comes to the maximum or minimum voltage ratings. Because V_{OUT} generally alternates between two voltages during DCLL operations (shown in FIGS. 2 and 4 as S1 and S2), two different voltage margins can be determined: a) the difference between the V_{MAX} value 326 and S1, and b) the difference between S2 and the V_{MIN} value 328. If the two margin values differ, industry designers and manufacturers of power stage controller devices are generally required to report the smaller voltage margin (e.g., the worst-case performance) on a data sheet.

Generally, power stage controller devices set the values of S1 and S2 equidistant from the V_{MAX} value 326 and the V_{MIN} value 328, respectively, to maintain equal voltage margins and report the same to customers. However, if the power stage controller devices send inaccurate PWM signals to the power stage circuits 304 during high frequency transient use cases, the values of S1 and S2 may shift inadvertently. For example, the graph 502 shows that S2 is below the safety threshold value 330B. As used above and herein, the safety threshold values 330A and 330B represent static voltages. The safety threshold values are selected such that (V_{MAX}₃₂₆ - safety threshold_{330A}) = (safety threshold_{330B} - V_{MIN 328}). If S1 and S2 were equidistant, S2 would be greater than the safety threshold value 330B. Instead, the graph 402 shows (V_{MAX}₃₂₆ - safety threshold_{330A}) > (safety threshold_{330B} - V_{MIN 328}) and the margin 422 as reduced (e.g., smaller in magnitude than margin 420). A power stage controller device that performs in such a manner would be evaluated based on the reduced margin 422 that occurs during high frequency transits.

To increase the value of margins and mitigate the negative performance effects of high frequency transients, some industry members choose to design the switching converter with more robust electrical components. Such a change in component design may include but is not limited to larger output capacitors, smaller inductors, faster power stage controller devices, etc. The changes may increase the value of V_{MAX} and decrease the value of V_{MIN} (compared to less robust components), thereby increasing the margins for V_{OUT}. However, the changes are expensive to implement and do not address the underlying problem: high frequency transient use cases cause the power stage controller device to send inaccurate inputs to the power stage circuits.

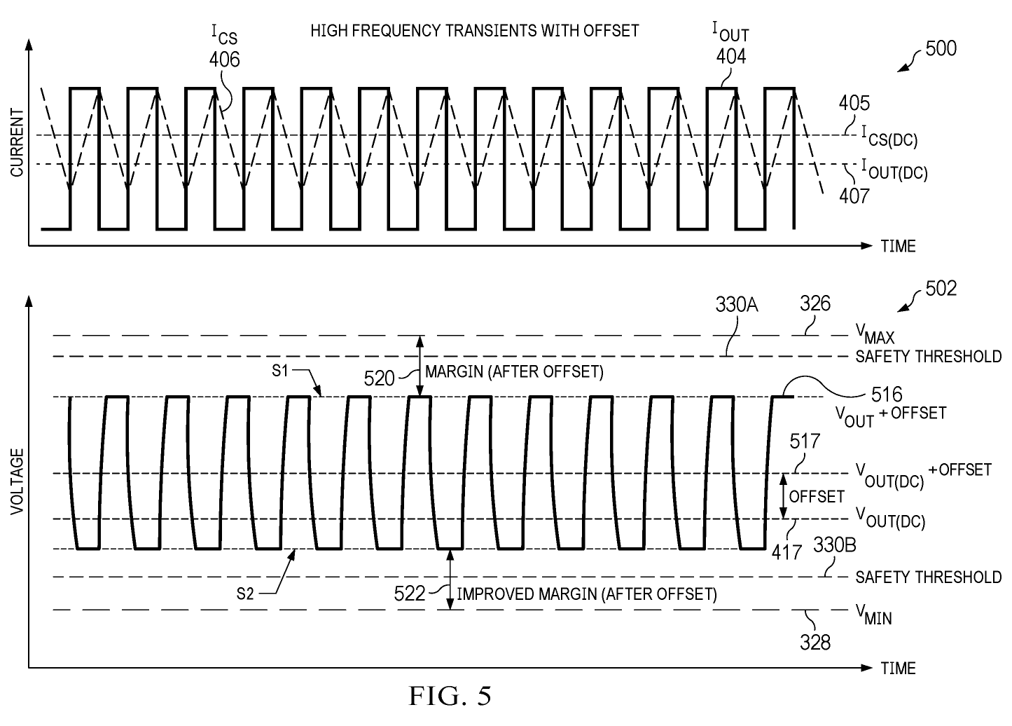

FIG. 5 are graphs illustrating the performance of the switching converter circuitry of FIG. 1 when operating with high frequency transients and with offsets. FIG. 5 includes example graphs 500 and 502. Graph 500 includes the I_{OUT} signal 404, the I_{OUT(DC)} signal 405, the I_{CS} signal 406, and the I_{CS(DC)} signal 407. Graph 502 includes the V_{MAX} value 326, the V_{MIN} value 328, the safety threshold value 330A and 330B, the V_{OUT(DC)} signal 417, an example (V_{OUT} + Offset) signal 516, an example (V_{OUT(DC)} + Offset) signal 517, and example margins 520 and 522.

In many examples, the power stage circuits 304 are designed and manufactured independently of the multiphase manager circuitry 302. Accordingly, the graph 500 of FIG. 5 matches the graph 400 of FIG. 4. The identical graphs indicate that, like other power stage controllers, the controller circuitry 310 receives an I_{CS(DC)} signal 407 that is shifted relative to the I_{OUT(DC)} signal 405 and therefore inaccurate.

Unlike other power stage controller devices, the controller circuitry 310 described herein continues to perform accurately during high frequency transients. To do so, the controller circuitry 310 determines the value of I_{OUT} by measuring the value of V_{OUT} instead of relying on the C_{SNS} terminals 314. In particular, the multiphase manager circuitry 302 already includes the V_{OUT} terminal 318 and the V_{SNS} terminal 320. These terminals and the adder 322 are generally used by the controller circuitry 310 to measure V_{OUT} across the capacitors 308, which is then used to perform control loop operations (such as, for example, Proportional, Integral, and Derivative (PID) operations) to keep V_{OUT} at a given set point voltage. Advantageously, the controller circuitry 310 also uses V_{OUT} to apply Ohm’s Law (I_{OUT} = V_{OUT} / R_{LL}). In the foregoing equation, I_{OUT} is thecurrent flowing to the load 110 and the desired information needed to perform DCLL operations, V_{OUT} is the voltage across the capacitors 308 and provided to the load 110, and R_{LL} is the load line resistance value stored in memory 324.

The controller circuitry 310 applies Ohm’s Law as described above to determine the value of the V_{OUT} signal 416 as shown in FIG. 4. The controller circuitry 310 determines that the value of the V_{OUT} signal 416 has fallen below the safety threshold value 330B. In response, the controller circuitry 310 applies a positive offset, causing the example (V_{OUT} + Offset) signal 516 to be provided to the load 110. FIG. 5 shows that example (V_{OUT} + Offset) signal 516 is greater than the safety threshold value 330B. FIG. 5 also shows that the average value of the new voltage provided to the load 110, (V_{OUT(DC)} + Offset) signal 517, is greater than the previous average value, V_{OUT(DC)} signal 417.

By applying the offset, the controller circuitry 310 readjusts the value of S1 and S2 to be equidistant from the V_{MAX} value 326 and the V_{MIN} value 328, respectively. Accordingly, the margins 520 and 522 are equal in magnitude to one another, and both margins are greater in magnitude than the margin 422 of FIG. 4. As such, the controller circuitry 310 can perform better in use cases with high frequency offsets than other power stage controller devices by applying an offset. Implementation of the offset value (e.g., when and how the offset value is applied) is described further in connection with FIGS. 6 and 7.

FIG. 6 is a first flowchart representative of example machine-readable instructions or example operations 600 that may be at least one of executed, instantiated, or performed by programmable circuitry to apply an offset value. The example machine-readable instructions or the example operations 600 of FIG. 6 begin when the controller circuitry 310 measures the V_{OUT} signal. (Block 602). The V_{OUT} signal refers to the difference between the voltage at the positive terminal of the capacitors 308 and a common voltage (e.g., ground). In the example of FIG. 3, the common voltage is provided by the V_{SNS} terminal 320 and the difference between voltages is determined by the adder 322. In other examples, the V_{OUT} measurement is based on a different common voltage. Also, or alternatively, the controller circuitry 310 implements the adder 322 internally and determines the difference between voltages itself.

The controller circuitry 310 determines whether the measured output voltage is above a first safety threshold. (Block 604). The first safety threshold of block 604 refers to the safety threshold value 330A of FIG. 3, which is similar in magnitude to the V_{MAX} value 326 and stored in the memory 324. A designer or manufacturer of the controller circuitry 310 can choose any value of the safety threshold value 330A, provided it is less than the V_{MAX} value 326. In some examples, the value of the safety threshold value 330A is based on a desired performance of the controller circuitry 310. For instance, a safety threshold value 330A closer to the value of the V_{MAX} value 326 may allow more room for overshoot, but less margin, than a safety threshold value 330A that is farther away to the value of the V_{MAX} value 326.

If the measured value of V_{OUT} is less than the first safety threshold (Block 604: No), the controller circuitry 310 waits for a period (Block 606) before control returns to block 602. Alternatively, if the measured value of V_{OUT} is greater than the first safety threshold (Block 604: Yes), the controller circuitry 310 increments a positive counter. (Block 608). The positive counter refers to a value that tracks the number of times the magnitude of the V_{OUT} signal was measured to be greater than the first safety threshold.

The controller circuitry 310 determines whether the positive counter satisfies a counting threshold. (Block 610). The counting threshold may refer to any positive integer. In the example of FIG. 6, a value satisfies the counting threshold if the value is greater or equal to the counter threshold. Similarly, the value fails to satisfy the counting threshold if the value is less than the counter threshold. In other examples, the counting threshold is satisfied or not satisfied using a different technique. The controller circuitry 310 implements the counting threshold at block 610 because, in some examples, overshoot may cause the V_{OUT} signal to occasionally exceed the safety threshold 330A and produce voltage bounces that do not notably change the average value of the V_{OUT} signal. Accordingly, the controller circuitry 310 implements block 610 to ensure the offset value is only changed when the setpoint voltage S1 has actually shifted upwards and the margin 420 is actually decreasing. In some examples, the execution of blocks 608 - 610 and blocks 616 - 618 may be referred to as deglitching or debouncing operations.

If the positive counter fails to satisfy the counting threshold (Block 610: No), the controller circuitry 310 waits for a period (Block 606) before control returns to block 602. Alternatively, if the positive counter does satisfy the counting threshold (Block 610: Yes), the controller circuitry decreases an offset value. (Block 612). As used above and herein, an offset value may be any real number (e.g., positive or negative, an integer or floating point) that is interpretable by the controller circuitry 310. The controller circuitry 310 may decrease the offset value at any amount at block 612 based on factors including but not limited to, the type of offset value (e.g., integer vs. floating point), the value of the counting threshold, performance requirements, etc.

In examples described herein, the offset value of FIG. 6 is proportional in both direction and magnitude to difference between the offset shown in graph 502 of FIG. 5. In FIG. 5, the offset value is positive, so (V_{OUT(DC)} + Offset) signal 517 is greater than the V_{OUT(DC)} signal 417. Similarly, if the offset value is negative, then the (V_{OUT(DC)} + Offset) signal 517 would be less than the V_{OUT(DC)} signal 417.

FIG. 6 shows that, after execution of block 602 and in parallel with the execution of block 604, the controller circuitry 310 determines whether the measured value of V_{OUT} is below a second safety threshold. (Block 614). The second safety threshold of block 614 refers to the safety threshold value 330B of FIG. 3, which is similar in magnitude to the V_{MIN} value 328 and stored in the memory 324. Like the safety threshold value 330A, a designer or manufacturer of the controller circuitry 310 can choose any value for the safety threshold value 330B provided that: a), the safety threshold value 330B is greater than the V_{MIN} value 328, and b) (V_{MAX}₃₂₆ - safety threshold_{330A}) = (safety threshold_{330B} - V_{MIN 328}).

If the measured value of V_{OUT} is greater than the second safety threshold (Block 614: No), the controller circuitry 310 waits for a period (Block 606) before control returns to block 602. Alternatively, if the measured value of V_{OUT} is less than the second safety threshold (Block 604: Yes), the controller circuitry 310 increments a negative counter (Block 616). The negative counter refers to a value that tracks the number of times the magnitude of the V_{OUT} signal was measured to be less than the second safety threshold.

The controller circuitry 310 determines whether the negative counter satisfies the counting threshold (Block 618). In the example of FIG. 6, the controller circuitry 310 uses the same counting threshold at blocks 610 and 618. In other examples, the controller circuitry 310 uses two different counting thresholds for the two use cases: a) when V_{OUT} is greater than the first safety threshold, and b) when V_{OUT} is less than the second safety threshold. As described above, the use of the counting threshold helps to ensure that adjustments to the offset value only occur in response to notable changes to the magnitude or direction of the V_{OUT(DC)} signal.

If the negative counter fails to satisfy the counting threshold (Block 618: No), the controller circuitry 310 waits for a period (Block 606) before control returns to block 602. Alternatively, if the negative counter does satisfy the counting threshold (Block 618: Yes), the controller circuitry increases the offset value. (Block 620). Notably, the controller circuitry performs opposite changes to the offset values at block 612 and 620. Thus, the decision whether to increase or decrease the value of the V_{OUT(DC)} signal depends on which safety threshold (at block 604 and 614) was crossed.

In the example of FIG. 6, the controller circuitry 310 implements blocks 604 - 612 in parallel with blocks 614 - 620. In other examples, the controller circuitry 310 implements blocks 604 - 620 serially, or in a different order.

The controller circuitry 310 produces one or more PWM signals based on the offset value (Block 622). The controller circuitry 310 produces one PWM signal per PWM terminal 312. Similarly, the multiphase manager circuitry 302 includes one PWM terminal 312 per power stage circuit 304. As described above, a PWM signal refers to a rectangular waveform whose pulse width and timing are determined by the controller circuitry 310. In examples described herein, the high side power transistor within the power stage circuitry 204A is powered ON, and the corresponding low side power transistor is powered OFF, when the corresponding PWM signal is at a logical 1 (e.g., at the high supply voltage that defines the top of the rectangular waveform). Therefore, the amount of power generated by the power stage circuitry 304A and provided to the load 110 is proportional to the duty cycle of the signal provided by the controller circuitry 310 at the PWM terminal 312A.

Advantageously, the controller circuitry 310 implements block 622 by adjusting the duty cycle of one or PWM signals so that it is proportional to a target average magnitude of V_{OUT}. For example, if the controller circuitry 310 received the V_{OUT} signal 416 of FIG. 4, it would implement block 620 and increase the offset value because the V_{OUT} signal 416 was repeatedly measured below the safety threshold value 330B. The increase in offset value then causes the controller circuitry 310 to increase the duty cycle of one or more PWM signals at block 622. In turn, the corresponding power stage circuits 304 provide more power to the load 110 than they were previously. As a result, the average value of V_{OUT} shifts upwards as shown in FIG. 5 by the (V_{OUT(DC)} + Offset) signal 517, the margins return to an equal value (e.g., margin 520 and 522 are equal in FIG. 5 whereas margin 420 and 422 are unequal in FIG. 4), and the V_{OUT} signal is no longer in danger of crossing the V_{MIN} value 328.

Similarly, if the V_{OUT} signal was instead repeatedly measured as being greater than the safety threshold 330A, the controller circuitry 310 would implement block 612 and decrease the offset value. The decrease in offset value then causes the controller circuitry 310 to decrease the duty cycle of one or more PWM signals at block 622. In turn, the corresponding power stage circuits 304 provide less power to the load 110 than they were previously, the average value of V_{OUT} shifts downwards so that the margins can return to an equal value, and the V_{OUT} signal is no longer in danger of crossing the V_{MAX} value 326.

FIG. 6 shows block 622 occurring after either block 612 or 620. In practice, the controller circuitry 310 may continually generate and adjust the PWM signals based on the power requirements of the load 110. Accordingly, the position of block 622 in FIG. 6 indicates that the controller circuitry 310 performs additional adjustments to duty cycle of the PWM signals in response to a change in the offset value (e.g., at block 612 or 620).

The controller circuitry 310 determines whether to take another measurement of V_{OUT} (Block 624). In some examples, the controller circuitry 310 repeatedly measures V_{OUT} measurements to ensure the margins 520 and 522 remain equal while the switching converter circuitry 108 is powered ON and performing operations. The controller circuitry 310 may take an additional measurement of V_{OUT} for any reason (e.g., based on a clock signal, in response to an external condition, etc.).

If the controller circuitry 310 decides to take another measurement (block 624: Yes), the controller circuitry 310 first resets the positive counter of block 608 and the negative counter of block 616 (Block 626). The controller circuitry 310 resets the counters because, to perform deglitching operations, the controller circuitry 310 determines the number of times VOUT has crossed one of the safety threshold values 330A or 330B since the last adjustment to the offset value. Accordingly, the values of the positive counter and the negative counter are only relevant within a single iteration of blocks 602 - 622.

In contrast to the positive counter value and the negative counter value, the changes to the offset value at blocks 612 and 620 are iterative adjustments based on the previous offset value. Accordingly, the controller circuitry 310 does not reset the offset value at block 626. Rather, the offset value remains present in memory 324 to be used and adjusted in subsequent iterations of blocks 602 - 622.

After block 626, control returns to block 602 where the controller circuitry 310 takes a new measurement of the V_{OUT} signal. If the controller circuitry 310 decides not to take another measurement (block 624: No), the machine-readable instructions or operations 600 end.

FIG. 7 is a second flowchart representative of example machine-readable instructions or example operations 700 that may be at least one of executed, instantiated, or performed by programmable circuitry to apply an offset value. The flowchart of FIG. 7 is one example implementation of how the controller circuitry 310 may implement the machine-readable instructions or operations 600 of FIG. 6. In other examples, the controller circuitry 310 implements machine-readable instructions or operations 600 differently as described above.

The flowchart of FIG. 7 begins when the controller circuitry 310 loads the V_{MAX} value 326 and the V_{MIN} value 328 from user programming or from the memory 324. (Block 702). As used in block 702, user programming may refer to any technique in which a user may provide values to programmable circuitry. For example, user programming may refer to an external device that is configured by a user to: a) couple to the multiphase manager circuitry 302 with one or more terminals, and b) transmit one or more signals representing the V_{MAX} value 326 and the V_{MIN} value 328 over the one or more terminals to the controller circuitry 310.

The controller circuitry 310 samples information from the V_{SNS} terminal 320 continuously. (Block 704). The information provided from the V_{SNS} terminal 320 is indicative of the value of V_{OUT} as used herein and shown in FIG. 3. As used above, continuous sampling of the V_{SNS} terminal 320 may refer to sampling that occurs repeatedly at any frequency, in response to any condition, etc. Accordingly, block 704 is an example implementation of block 602 of FIG. 6, where the controller circuitry 310 measures the V_{OUT} signal.

The controller circuitry 310 captures maximum and minimum values of the V_{OUT} signal during transients. (Block 706). The maximum value of the V_{OUT} signal refers to the setpoint voltage S1 as shown in FIGS. 4 and 5. Similarly, the minimum value of the V_{OUT} signal refers to the setpoint voltage S2 as shown in FIGS. 4 and 5. The controller circuitry 310 specifically identifies the values of S1 and S2 because any measurements of V_{OUT} betweenS1 and S2 are not minimum values or maximum values that will affect the voltage margin of the device. In the example of FIG. 7, the controller circuitry 310 identifies the values of S1 and S2 during use cases that cause high frequency transient because other use cases do not cause a shift in the V_{OUT} signal that can affect the voltage margin. In other examples, the controller circuitry 310 does identify the maximum and minimum values of the V_{OUT} signal during other use cases.

The controller circuitry 310 calculates margins by subtracting the maximum and minimum values of the V_{OUT} signal of block 706 from the V_{MAX} value 326 and the V_{MIN} value 32 of block 702. (Block 708). In some examples, the controller circuitry 310 performs different mathematical operations to calculate the margins as shown in FIGS. 4 and 5. For example, the controller circuitry 310 may subtract the values in a different order. Calculating the current margins of the V_{OUT} signal enables the controller circuitry 310 to determine whether the V_{OUT} signal has shifted past either of the safety threshold values 330A and 330B. Accordingly, blocks 706 and 708 of FIG. 7 are example implementations of blocks 604 and 614 of FIG. 6.

The controller circuitry 310 applies a low pass filter to avoid abrupt changes to the value of V_{OUT}. (Block 710). In the example flowchart of FIG. 6, the controller circuitry 310 applies the low pass filter of block 710 by implementing blocks 604, 608, 614, and 616.

The controller circuitry 310 applies an offset to the voltage setpoint to maximize both the V_{MAX} and V_{MIN} margins. (Block 712). Because the offset changes the values of both S1 and S2 proportionally, and the performance of the multiphase manager circuitry 302 is measured by the lowest margin, the maximization of the V_{MAX} and V_{MIN} margins referred to in block 712 occurs when both margins are equal. Accordingly, block 712 of FIG. 7 is an example implementation of blocks 610, 612, 618, 620, and 622 of FIG. 6.

The controller circuitry 310 determines whether to continue performing operations. (Block 714). If the controller circuitry 310 does continue performing operations, (Block 714: Yes), the controller circuitry 310 may reset one or more internal parameters before control returns to block 704. If instead the controller circuitry 310 stops performing operations, (Block 716: No), the machine-readable instructions and/or operations 700 end. Accordingly, block 714 of FIG. 7 is an example implementation of block 624 of FIG. 6.

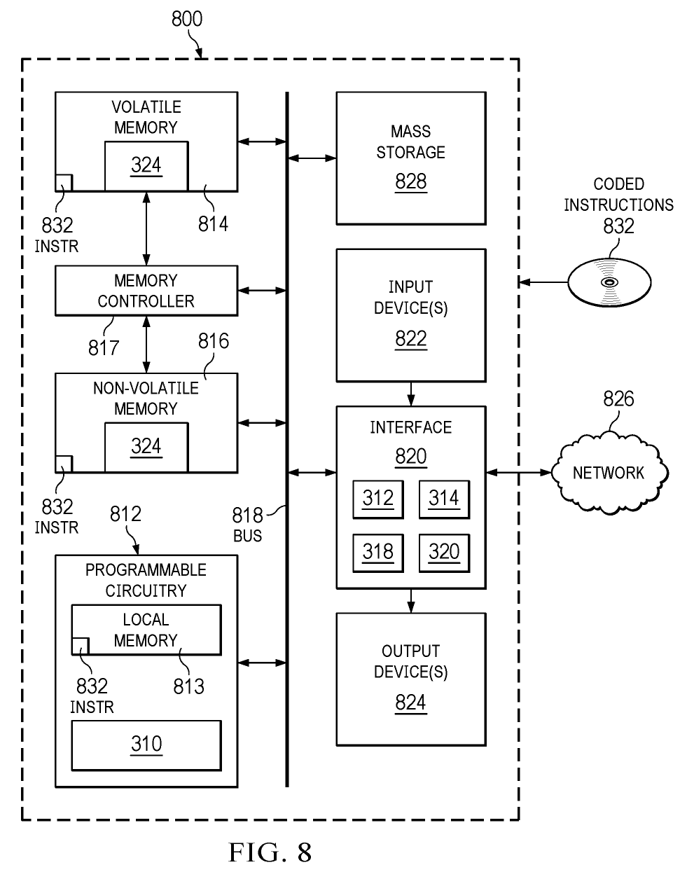

FIG. 8 is a block diagram of an example programmable circuitry platform 800 structured to one or a combination of execute or instantiate one or more of the example machine-readable instructions or the example operations of FIGS. 6 and 7 to implement the multiphase manager circuitry 302 of FIG. 3. The programmable circuitry platform 800 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, or microcontrollers from any desired family or manufacturer. The programmable circuitry 812 may be implemented by one or more semiconductor based (e.g., silicon based) devices. In this example, the programmable circuitry 812 implements the controller circuitry 310.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 816 may be implemented by one or a combination of flash memory or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter one of or a combination of data or commands into the programmable circuitry 812. The input device(s) 822 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 824 are also connected to the interface circuitry 820 of the illustrated example. The output device(s) 824 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 820 of the illustrated example, thus, includes one of or a combination of a graphics driver card, a graphics driver chip, or graphics processor circuitry such as a GPU. In this example, the interface circuitry 820 implements the PWM terminals 312, the C_{SNS} terminals 314, the V_{OUT} terminal 318, and the V_{SNS} terminal 320.

The interface circuitry 820 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store one or more of firmware, software, or data. Examples of such mass storage discs or devices 828 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 832, which may be implemented by the machine-readable instructions of FIGS. 6 and 7, may be stored in one of or a combination of the mass storage device 828, in the volatile memory 814, in the non-volatile memory 816, or on at least one non-transitory computer readable storage medium such as a CD or DVD which may be removable.

While an example manner of implementing the multiphase manager circuitry 302 of FIG. 1 is illustrated in FIG. 3, one or more of the elements, processes, or devices illustrated in FIG. 3 may be combined, divided, re-arranged, omitted, eliminated, or implemented in any other way. Further, the controller circuitry 310, the PWM terminals 312, the C_{SNS} terminals 314, the adders 316 and 322, the V_{OUT} terminal 318, the V_{SNS} terminal 320, or, more generally, the example multiphase manager circuitry 302 of FIG. 3, may be implemented by hardware alone or by hardware in combination with software and firmware. Thus, for example, any of the controller circuitry 310, the PWM terminals 312, the C_{SNS} terminals 314, the adders 316 and 322, the V_{OUT} terminal 318, the V_{SNS} terminal 320, or, more generally, the example multiphase manager circuitry 302 of FIG. 3, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example multiphase manager circuitry 302 of FIG. 3 may include one or more elements, processes, or devices in addition to, or instead of, those illustrated in FIG. 3, or may include more than one of any or all of the illustrated elements, processes and devices.

Flowcharts representative of example machine-readable instructions, which may be executed by programmable circuitry to at least one of implement or instantiate the multiphase manager circuitry 302 of FIG. 3 or representative of example operations which may be performed by programmable circuitry to at least one of implement or instantiate the multiphase manager circuitry 302 of FIG. 3, is shown in FIGS. 6 and 7. The machine-readable instructions may be one or more executable programs or portion(s) of one or more executable programs for execution by programmable circuitry such as the programmable circuitry 812 shown in the example programmable circuitry platform 800 described below in connection with FIG. 8 and may be one or more function(s) or portion(s) of functions to be performed by the example programmable circuitry (e.g., an FPGA). In some examples, the machine-readable instructions cause an operation, a task, etc., to be carried out or performed in an automated manner in the real-world. As used herein, “automated” means without human involvement.

The program may be embodied in instructions (e.g., software or firmware) stored on one or more non-transitory computer readable or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6 and 7, many other methods of implementing the example multiphase manager circuitry 302 may alternatively be used. For example, the order of execution of the blocks of the flowchart(s) may be changed, or some of the blocks described may be changed, eliminated, or combined. Also, or alternatively, any or all of the blocks of the flow chart may be implemented by one or more hardware circuits (e.g., processor circuitry, discrete, integrated analog or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks, or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., so they are directly readable, interpretable, or executable by a computing device or other machine. For example, the machine-readable instructions may be stored in multiple parts, which are individually compressed, encrypted, or stored on separate computing devices, wherein the parts when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6 and 7may be implemented using executable instructions (e.g., computer readable or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/- 10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description.

Modifications are possible in the described embodiments, and other embodiments are possible, within the scope of the claims.

From the foregoing, it will be appreciated that example systems, apparatus, articles of manufacture, and methods have been described that perform DCLL control operations accurately in high frequency transient use cases and without relying on C_{SNS} signals from power stage circuits. Described systems, apparatus, articles of manufacture, and methods improve the efficiency of using a computing device by measuring the value of V_{OUT} to determine I_{OUT} (as opposed to relying on C_{SNS} signals to determine I_{OUT}), by comparing the measured V_{OUT} value to safety threshold values near the minimum and maximum voltage ratings, and by adjusting the duty cycle of PWM signals in response to the measured VOUT value crossing a safety threshold value. As a result, power stage controller devices implemented according to the examples herein can perform DCLL control operations more accurately in high frequency transient use cases than power stage controller devices that rely on C_{SNS} signals. Described systems, apparatus, articles of manufacture, and methods are also directed to one or more improvement(s) in the operation of a machine such as a computer or other electronic, electromechanical, or mechanical device.

What is claimed is:

1. An apparatus comprising:
memory configured to store a value representative of a threshold voltage;
controller circuitry having:
a first input terminal coupled to the memory;
a second input terminal; and
an output terminal;
the controller circuitry configured to:
receive, at the second input terminal, an indication of an output voltage;
adjust, in response to a determination that the output voltage is outside the threshold voltage, an offset value; and
provide, at the output terminal, an output signal based on the offset value.

2. The apparatus of claim 1, wherein to provide the output signal, the controller circuitry is further configured to:
modify a duty cycle of a pulse width modulation (PWM) signal based on the offset value, the value of the output voltage responsive to the duty cycle.

3. The apparatus of claim 1, wherein:
the threshold voltage is a first threshold voltage;
the memory is further configured to store a second threshold voltage; and
the controller circuitry is further configured to increase, in response to a determination the output voltage is below the second threshold voltage, the offset value.

4. The apparatus of claim 3, wherein the memory is further configured to store:
a maximum voltage corresponding to a safety rating of the apparatus, the first threshold voltage less than the maximum voltage; and
a minimum voltage corresponding to the safety rating of the apparatus, the second threshold voltage greater than the maximum voltage.

5. The apparatus of claim 4, wherein:
a difference between the output voltage and the maximum voltage is a first margin;
a difference between the output voltage and the minimum voltage is a second margin;
the first margin becomes unequal to the second margin in response to a high frequency transient mode without modifications to the output signal; and
the controller circuitry is configured to modify the output signal such that the first margin and the second margin remain equal to one another.

6. The apparatus of claim 1, wherein the controller circuitry is configured to:
increment a counter value in response to the output voltage exceeding the threshold voltage; and
modify the offset value in response to the counter value exceeding a threshold value.

7. The apparatus of claim 1, wherein:
the output voltage is responsive to the output signal; and
the controller circuitry is configured to provide the output signal such that the offset value is proportional to a target average magnitude of the output voltage.

8. A system comprising:
memory configured to store a value representative of a threshold voltage;
power stage circuitry;
a capacitor coupled to the power stage circuitry; and
multiphase manager circuitry having:
a first input terminal coupled to the memory;
a second input terminal coupled to the capacitor; and
an output terminal coupled to the power stage circuitry;
the multiphase manager circuitry configured to:
receive, at the second input terminal, an indication of an output voltage across the capacitor;
adjust, in response to a determination the output voltage is outside the threshold voltage, an offset value; and
provide, at the output terminal, a pulse width modulation (PWM) signal to the power stage circuitry based on the offset value.

9. The system of claim 8, wherein the multiphase manager circuitry is configured to:
determine an output current flowing to a load based on the output voltage; and
perform Direct Current Load Line (DCLL) control operations to adjust a setpoint of the output voltage as a function of the output current, the DCLL control operations including providing the PWM signal to the power stage circuitry.

10. The system of claim 9, wherein:
the multiphase manager circuitry has a third input terminal coupled to the power stage circuitry; and
the multiphase manager circuitry is configured to provide, using the third input terminal, a voltage to the multiphase manager circuitry corresponding to the output current.

11. The system of claim 10, wherein:
the multiphase manager circuitry is configured to operate the power stage circuitry in a high frequency transient mode using the PWM signal; and
the multiphase manager circuitry is configured to determine the PWM signal based on the output current corresponding to the output voltage.

12. The system of claim 8, wherein:
the power stage circuitry is configured to adjust a magnitude of the output voltage based on a duty cycle of the PWM signal; and
the multiphase manager circuitry is configured to adjust the duty cycle of the PWM signal based on the offset value.

13. The system of claim 8, wherein:
the threshold voltage is a first threshold voltage;
the memory is further configured to store a second threshold voltage; and
the multiphase manager circuitry is further configured to increase, in response to a determination the output voltage is below the second threshold voltage, the offset value.

14. The system of claim 13, wherein the memory is further configured to store:
a maximum voltage corresponding to a safety rating of the system, the first threshold voltage less than the maximum voltage; and
a minimum voltage corresponding to the safety rating of the system, the second threshold voltage greater than the maximum voltage.

15. The system of claim 8, wherein:
the power stage circuitry is first power stage circuitry;
the output terminal is a first output terminal;
the PWM signal is a first PWM signal;
the multiphase manager circuitry further includes a second output terminal coupled to second power stage circuitry; and
the multiphase manager circuitry is further configured to provide, at the second output terminal, a second PWM signal to the second power stage circuitry based on the offset value.

16. The system of claim 8, wherein the multiphase manager circuitry is configured to:
increment a counter value in response to the output voltage exceeding the threshold voltage; and
modify the offset value in response to the counter value exceeding a threshold value.

17. The system of claim 8, wherein:
the output voltage is responsive to the PWM signal; and
the multiphase manager circuitry is configured to provide the PWM signal such that the offset value is proportional to a desired average magnitude of the output voltage.

18. A method to adjust load transient margins, the method comprising:
obtaining, by controller circuitry, a value representative of a threshold voltage from memory;
receiving, by the controller circuitry, an indication of an output voltage;
adjusting, by the controller circuitry, in response to a determination that the output voltage is outside the threshold voltage, an offset value; and
providing, by the controller circuitry, a pulse width modulation (PWM) signal based on the offset value.

19. The method of claim 18, further including:
determining an output current flowing to a load based on the output voltage; and
performing Direct Current Load Line (DCLL) control operations to adjust a setpoint of the output voltage as a function of the output current, the DCLL control operations including providing the PWM signal.

20. The method of claim 18, further including:
adjusting a magnitude of the output voltage based on a duty cycle of the PWM signal; and
adjusting the duty cycle of the PWM signal based on the offset value.
